(19) United States
(12) Patent Application Publication
(10) Pub. No.: US 2013/0188452 A1
(43) Pub. Date: Jul. 25, 2013

(54) ASSESSING STRESS STRAIN AND FLUID PRESSURE IN STRATA SURROUNDING A BOREHOLE BASED ON BOREHOLE CASING RESONANCE

(71) Applicants: Andre ST-ONGE, Calgary (CA); David EATON, Calgary (CA); Adam PIDLISECKY, Calgary (CA)

(72) Inventors: Andre ST-ONGE, Calgary (CA); David EATON, Calgary (CA); Adam PIDLISECKY, Calgary (CA)

(21) Appl. No.: 13/353,376

(22) Filed: Jan. 19, 2012

(51) Int. Cl. G01V 1/40

(52) U.S. Cl. 367/35

(57) ABSTRACT

A method of determining a physical property of subsurface strata surrounding a borehole. The physical property includes any one or more of stress, strain of fluid pressure of the subsurface strata. The borehole includes a borehole liner having an interior wall. A pair of sensor modules separated by a known distance are clamped to the interior wall of the borehole liner. The clamping induces an acoustic discontinuity in the borehole liner such that a P-wave propagating longitudinally within the borehole liner is at least partially reflected. A respective sensor of each sensor module detecting P-waves propagating in the liner and generating a corresponding sensor output signal indicative of the detected P-waves. A respective sensor output signal from each sensor module is analyzed to detect a resonance in a section of the borehole liner between the sensors. A fundamental frequency of the detected resonance is determined and analyzed to determine the physical property.

### CROSS-REFERENCE TO RELATED APPLICATIONS

This is the first application filed in respect of the present invention.

### FIELD OF THE INVENTION

The present application relates generally to detecting physical properties of strata surrounding a borehole, and more specifically to methods of assessing physical properties of strata surrounding a borehole based on borehole casing resonance.

### BACKGROUND

In a variety of situations, principally in oil and gas exploration, but also in mining, environmental and civil engineering, there may be advantages to obtaining data indicative of geological properties of a given subterranean zone (for example, the size and density of a geological formation below the surface of the earth). Typically, this is accomplished by lowering one or more seismic detectors into a borehole to a depth determined to be appropriate for the acquisition of seismic data relevant to the target zone. The seismic detectors are commonly provided as “geophones” and/or accelerometers, both of which detect movements or vibrations from which various geological properties of the surrounding strata may be inferred.

It is common practice, particularly in oil and gas exploration, to install a liner or casing within a borehole, to resist deformation and collapse of the borehole walls. In deep boreholes, the liner is typically made of steel, while plastic liners may be used for shallow monitoring holes or water wells. In either case, a cementicious grout is typically forced into the space between the liner and the surrounding rock. This means that one or more seismic detectors clamped to the interior wall of the borehole casing can detect movement and vibrations in the surrounding rock strata. The signals output from the detectors can thus be analyzed to deduce geological properties of a target zone.

U.S. patent publication No., 2011/0222368 discloses a known seismic tool system of the type described above, in which comprising one or more seismic tools are suspended from a cable and lowered into a borehole. Each seismic tool includes at least one seismic sensor (e.g. a geophone or an accelerometer) enclosed within a housing; one or more rollers attached to the housing and acoustically coupled to the sensor(s); and a bow spring attached to the housing and including one or more rollers adapted to engage the borehole. With this arrangement, the bow spring forces the rollers into contact with the borehole casing, so that vibrations in the rock surrounding the borehole can be transferred to and detected by the sensors. Other known techniques for clamping a seismic detector to the interior wall of the borehole casing include various mechanical clamping mechanisms, and the use of electromagnets as described in U.S. Pat. No. 4,953,136

Additionally, U.S. patent publication No., 2011/0222368 discloses that there are typically two methods for recording seismic data in boreholes: active and passive. In active seismic recording, an energy source may be used to generate waves that travel through the subterranean zone and are recorded by one or more seismic sensors installed in the seismic tools. Such sources include explosives placed below ground level in drilled holes, large truck mounted devices called “vibrators,” or a variety of other methods of introducing energy into the subsurface. In passive seismic data recording, a signal received by the seismic tool may be generated by ambient noise occurring with the Earth. They can also be generated by movements within the earth's subsurface, often referred to as “micro-quakes,” and passive seismic signals often called “micro-seismic.”

In principle, the detection of micro-quakes can be used to infer levels of stress and/or pressure within a subsurface zone. However, in many cases it would be desirable to directly measure these properties.

Canadian patent number 1,075,932 describes a sensor for measuring changes in the stress of subsurface rock formations. The sensor comprises a housing in which there is mounted a calibrated wire and a mechanism for plucking the calibrated wire. The housing is designed to be secured within a borehole, such that changes in the stress level of the rock surrounding the borehole distorts the housing and causes a corresponding change in the natural frequency of vibration of the calibrated wire. Accordingly by periodically plucking the wire and measuring changes in the natural frequency of the wire, changes in the stress level of the rock surrounding the borehole can be determined. However, the system of Canadian patent number 1,075,932 suffers a limitation in that the sensor requires a calibrated wire, which tends to be delicate, and which must therefore be frequently adjusted to maintain calibration. Furthermore, the sensor only detects the stress of the rock immediately surrounding the sensor itself. In many cases, it would be desirable to detect the stress field distributed over a (potentially) significant length of the borehole.

Techniques of measuring physical properties of subsurface strata that overcome at least some limitations of the prior art, remain highly desirable.

### SUMMARY

An aspect of the present invention provides a method of determining a physical property of subsurface strata surrounding a borehole. The borehole includes a borehole liner having an interior wall. A pair of sensor modules separated by a known distance are clamped to the interior wall of the borehole liner. The clamping induces an acoustic discontinuity in the borehole liner such that an elastic wave propagating longitudinally within the borehole liner is at least partially reflected. A respective sensor of each sensor module detecting elastic waves propagating in the liner and generating a corresponding sensor output signal indicative of the detected elastic waves. A respective sensor output signal from each sensor module is analyzed to detect a resonance in a section of the borehole liner between the sensors. A fundamental frequency of the detected resonance is determined and analyzed to determine the physical property. The physical property may be any one or more of subsurface stress, strain and fluid pressure.

### BRIEF DESCRIPTION OF THE DRAWINGS

Further features and advantages of the present invention will become apparent from the following detailed description, taken in combination with the appended drawings, in which:

FIG. 1 schematically illustrates a system for measuring subsurface strain;

FIG. 2 schematically illustrates features of the system of FIG. 1 in greater detail; and

FIGS. 3a and 3b show representative power spectra obtained from a sensor module of FIGS. 1 and 2.

It will be noted that throughout the appended drawings, like features are identified by like reference numerals.

### DETAILED DESCRIPTION

The present applicants have observed that the materials using in borehole casings (typically steel alloys or plastic) are elastic materials in which an elastic wave will propagate at a characteristic speed which is a function of the stress of the liner material. The present applicants have leveraged this observation to provide apparatus and methods of measuring distributed physical properties such as stress, strain and fluid pressure in subsurface strata.

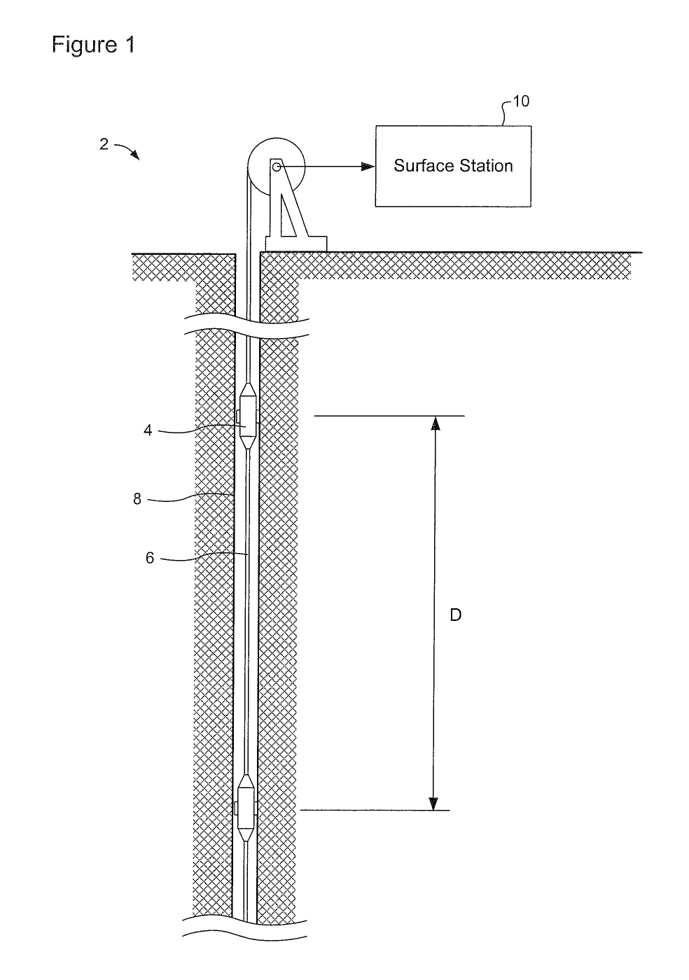

Referring to FIG. 1, there is schematically shown a representative monitoring system 2 in which sensor modules 4 are mounted at spaced intervals along a string 6 and suspended at a desired depth within a borehole 8. Each sensor module 4 may communicate with a surface station 10 via suitable cables (not shown). The surface station 10 may include one or more signal analyzers (such as, for example, suitably programmed computers) for analysing signals received from the sensor modules 4. In some embodiments, the surface station 10 may include recording equipment for recording signals received from the sensor modules 4, so as to enable subsequent analysis.

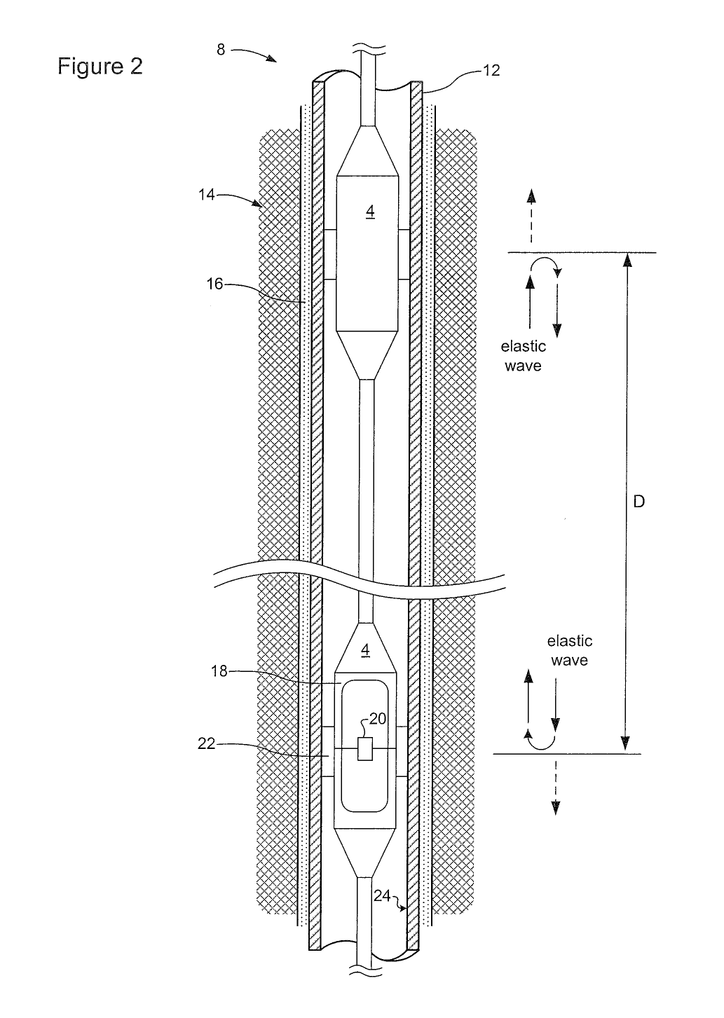

As may be seen in FIG. 2, the borehole 8 comprises a conventional borehole liner or casing 12 surrounded by subsurface strata 14. A cement grout 16 is disposed between the borehole casing 12 and the subsurface strata 14, in a conventional manner. Due to the material properties of the borehole liner material (e.g. steel or plastic), an elastic wave can propagate longitudinally within the liner with a speed (v) that is dependent on the liner material and its internal stress level.

Each sensor module 4 generally comprises a housing 18; a sensor 20 disposed within the housing 18; and a clamping mechanism 22 for bearing on the interior wall 24 of the borehole casing 12 and acoustically coupled to the sensor 20 such that the sensor 20 can detect elastic waves propagating in the borehole casing 12. The housing 18 may be of any suitable material and construction. The sensor 20 may be provided as a conventional geophone or an accelerometer, both of which are well known in the art and commercially available. In some embodiments, a conventional single-axis accelerometer is used, which is mounted to detect vibrations along the axis of the borehole. In other embodiments, a conventional two or three-axis accelerometer is used, which is mounted to detect vibrations along the axis of the borehole and in one or two axes orthogonal to the borehole axis.

The sensor 20 may be either analog or digital. In the case of a digital sensor 20, the sensor 20 is preferably configured to output a digital signal having a known resolution and sample rate. In some embodiments, the digital signal has a resolution of 8-bits or more, but this is not essential. In general, any suitable resolution may be used, which will enable reliable detection and analysis of elastic waves propagating in the borehole liner 12. The sample rate of the digital signal is preferably selected to be at least double the expected frequency of the highest frequency elastic wave of interest. In the case of an analog sensor, it may be convenient to convert the analog signal output from the detector to a corresponding digital signal, for example using an analog to digital converter (ADC) having a known resolution and sample rate. The resolution and sample rate of the ADC are preferably chosen using the same considerations described above for the case of a digital sensor. The ADC may be located either within the sensor module housing or at the surface station, as desired.

In some embodiments, high-pass or band-pass filters may be used to attenuate frequency components lying outside of an expected range of frequencies of elastic waves of interest.

The clamping mechanism 22 can be configured to secure the sensor module 4 to the borehole liner 12 using any suitable means. Well known magnetic or mechanical clamping systems may be used for this purpose. However, it is important that the clamping force be sufficiently large to produce a discontinuity in the elastic properties of the borehole liner 12 at the location of the sensor module 4. In some embodiments this discontinuity is produced solely by the clamping forces imposed on the borehole liner 12 by the clamping mechanism 22. In other embodiments the elastic discontinuity is produced by the clamping forces in combination with the mass of the sensor module 4. The effect of the elastic discontinuity is that an elastic wave propagating longitudinally within the borehole liner 12 will be at least partially reflected at the sensor module 4. In the illustrated embodiment, this means that a longitudinally propagating elastic waves will tend to be reflected back and forth between to two sensor modules 4, and thus can be detected by the respective sensors 20 in each sensor module 4 as a resonance at a fundamental frequency (F) and its harmonics.

The fundamental frequency F may be determined as the propagation speed (v) of the elastic wave divided by the distance D between the two sensor modules, and its harmonics will have integer multiples of this frequency in the usual manner. This establishes the frequency range of interest to be detected by the sensors 20. In particular, the sensors 20 are preferably configured to detect at least the fundamental frequency F of any resonance that is expected to be present in the borehole liner 12.

As noted above, the propagation speed (v) is dependent on the liner material, and its internal stress level. Since the liner material is fixed at the time of manufacture, any detected changes in the fundamental frequency F can be attributed to changes in the internal stress of the liner, and thus to physical properties such as stress, strain and fluid pressure in the surrounding strata. The relationship(s) between these physical properties and the liner stress can be found through theoretical numerical modelling and/or experimental testing.

Because the resonance is due to longitudinal propagation of the elastic wave between two sensor modules 4, changes in the fundamental frequency F will in fact relate to changes in the strain in the surrounding strata 14 distributed along the entire length of the borehole 8 between the two sensor modules 4, rather than just the local strain in the immediate vicinity of each module 4.

In operation, the sensor modules 4 are lowered into the borehole 8 to a desired depth, and the clamping mechanisms 22 activated to clamp each sensor module 4 to the interior wall 24 of the borehole liner 12. This operation acoustically couples the sensors 20 to the borehole liner 12, so that the sensors 20 can operate to detect elastic waves propagating in the liner. Each sensor 20 outputs a respective signal indicative of detected elastic waves, and transmits this signal to the surface station 10 for recording and/or analysis.

It has been found that it is frequently not necessary to excite or initiate longitudinally propagating elastic waves in the borehole liner 12. Naturally occurring ambient noise, movements and micro-quakes within the subsurface strata will normally excite random elastic waves within the liner 12. The reflection of some of these random waves at each sensor module 4 is sufficient to induce detectable resonances. However, if desired, a mechanism (not shown) for inducing elastic waves in the liner 12 may be provided, for example in association with each sensor module 4.

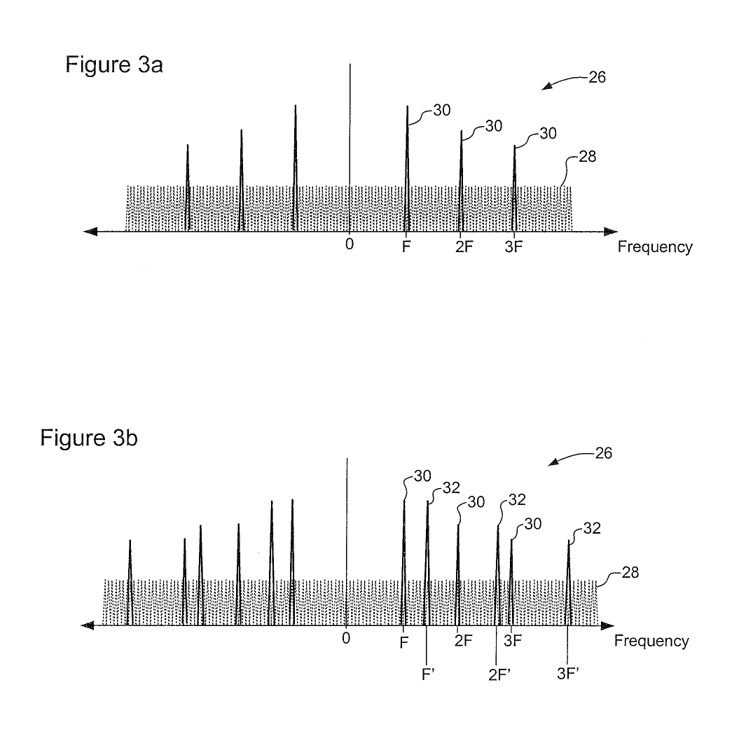

Various methods may be employed to analyse signals received from the sensors 20 to detect resonances, and determine subsurface physical properties. In one embodiment, a respective time series of signal values from each sensor module 4 is processed (for example, using a Fourier Transform or Fast Fourier Transform) to determine the power spectrum of the elastic waves detected by that sensor module 4. FIG. 3a illustrates a representative power spectrum 26 obtained from one sensor module 4. In the presence of random acoustic noise 28, a resonance in the borehole liner 12 can be identified by a set of one or more local maxima or peaks 30 within the power spectrum 26. In the spectrum 28 of FIG. 3a, a set of three regularly spaced peaks 30 (at frequencies of F, 2F and 3F) are shown, indicating the presence of a single resonance. The center frequency of the lowest frequency peak within the set corresponds with the fundamental frequency F, which can thus be determined and recorded. It may be noted that in cases in which a single peak is detected, the center frequency of that peak 30 can simply be taken as the fundamental frequency F.

As noted above, changes in this fundamental frequency F over time indicates corresponding changes in liner stress, which can be related to subsurface stress, and strain and fluid pressure. In addition, the relationship between the internal stress of the liner and the propagation speed (v) of an elastic wave in the liner material can be determined (e.g. by analytical methods or by experimental testing), as can the relationship between internal stress of the liner and subsurface stress, strain and fluid pressure of surrounding strata. Based on this information, changes in these subsurface physical properties during a selected study period can be determined from changes in the measured fundamental frequency F over that period.

It will be appreciated that the detected resonance is the product of reflection of a longitudinally propagating elastic wave back and forth between a pair of adjacent sensor modules 4. Consequently, both of the sensor modules will detect the same resonance, and this will result in corresponding sets of peaks 30 in the respective power spectra obtained from each sensor module 4. This means that correlated sets of peaks 30 in the respective power spectra 26 obtained from two adjacent sensor modules 4 indicates that the detected resonance is in the section of borehole 8 lying between the two sensor modules 4. In an embodiment in which there are only two sensor modules on the string 6, this result is trivial. However, in embodiments in which three or more sensor modules 4 are disposed on the string 6, this result can be used to properly associate each detected resonance to the respective section of the borehole 8 in which that resonance is located. The comparison of the harmonic resonances at different depth levels within the borehole may enable a vertical reconstruction of the stress within the borehole. The vertical resolution of this reconstruction can be controlled, and varied, by manipulation of the spacing between sensor modules 4, and the placement of sensor modules 4 within the borehole.

For example, FIG. 3b illustrates a power spectrum obtained from a sensor module 4 which is disposed between two other modules on the string. As such, the sensor module delimits two adjacent sections of the borehole 8, and will detect a respective resonance in each section, namely: a first resonance indicated by peaks 30 at frequencies F, 2F and 3F; and a second resonance indicated by peaks 32 at frequencies F′, 2F′ and 3F′. In the illustrated embodiment, each resonance has a respective different fundamental frequency F and F′, which may be due to different strain levels in the strata 14 surrounding each section. Of course setting a different distance D between the respective pairs of sensor modules 4 will also produce resonances with different fundamental frequencies in each section. Based on one power spectrum 26 alone it is not readily apparent which detected resonance is in each section. However, this problem can be resolved by correlating the spectrum with the respective spectra obtained from the adjacent sensor modules.

The embodiments of the invention described above are intended to be illustrative only. The scope of the invention is therefore intended to be limited solely by the scope of the appended claims.

We claim:

1. A method of determining a physical property of subsurface strata surrounding a borehole, the physical property comprising any one or more of stress, strain and fluid pressure in the subsurface strata, the borehole including a borehole liner having an interior wall, the method comprising:
clamping a pair of sensor modules separated by a known distance to the interior wall of the borehole liner, the clamping inducing an acoustic discontinuity in the borehole liner such that an elastic wave propagating longitudinally within the borehole liner is at least partially reflected;
a respective sensor of each sensor module detecting elastic waves propagating in the liner and generating a corresponding sensor output signal indicative of the detected P-waves;
analysing a respective sensor output signal from each sensor module to detect a resonance in a section of the borehole liner between the sensors;
determining a fundamental frequency of the detected resonance; and
analysing the fundamental frequency to determine the physical property.

2. The method of claim 1, wherein analysing a respective sensor output signal comprises:
determining a power spectrum of the sensor output signal; and identifying resonance in the power spectrum.

3. The method of claim 2, wherein determining a power spectrum of the sensor output signal comprises computing a Fast Fourier Transform.

4. The method of claim 2, wherein identifying a resonance in the power spectrum comprises detecting at least one local maximum in the power spectrum.

5. The method of claim 1, wherein analysing the fundamental frequency to determine the strain comprises:
determining a relationship between strain and propagation speed of an elastic wave in the liner;
detecting a change in the fundamental frequency; and
determining the strain based on the detected change in the fundamental frequency and the determined relationship between strain and propagation speed of an elastic wave in the liner.

6. A method of determining stress in a borehole liner, the method comprising:
clamping a pair of sensor modules separated by a known distance to the interior wall of the borehole liner, the clamping inducing an acoustic discontinuity in the borehole liner such that an elastic wave propagating longitudinally within the borehole liner is at least partially reflected;
a respective sensor of each sensor module detecting elastic waves propagating in the liner and generating a corresponding sensor output signal indicative of the detected P-waves;
analysing a respective sensor output signal from each sensor module to detect a resonance in a section of the borehole liner between the sensors;
determining a fundamental frequency of the detected resonance; and
analysing the fundamental frequency to determine the stress.

7. The method of claim 6, wherein analysing a respective sensor output signal comprises:
determining a power spectrum of the sensor output signal; and
identifying a resonance in the power spectrum.

8. The method of claim 7, wherein determining a power spectrum of the sensor output signal comprises computing a Fast Fourier Transform.

9. The method of claim 7, wherein identifying a resonance in the power spectrum comprises detecting at least one local maximum in the power spectrum

10. The method of claim 6, wherein analysing the fundamental frequency to determine the stress comprises:
determining a relationship between stress and propagation speed of an elastic wave in the liner;
detecting a change in the fundamental frequency; and
determining the stress based on the detected change in the fundamental frequency and the determined relationship between stress and propagation speed of an elastic wave in the liner.

11. A system for determining a physical property of subsurface strata surrounding a borehole, the physical property comprising any one or more of stress, strain and fluid pressure in the subsurface strata, the borehole including a borehole liner having an interior wall, the method comprising:
a pair of sensor modules configured to be clamped to the interior wall of the borehole liner and separated by a known distance, the clamping inducing an acoustic discontinuity in the borehole liner such that an elastic wave propagating longitudinally within the borehole liner is at least partially reflected;
a respective sensor of each sensor module detecting elastic waves propagating in the liner and generating a corresponding sensor output signal indicative of the detected elastic waves; and
a surface station configured to:
analyse a respective sensor output signal from each sensor module to detect a resonance in a section of the borehole liner between the sensors;
determine a fundamental frequency of the detected resonance; and analyse the fundamental frequency to determine the physical property.
